(19) United States
(12) Patent Application Publication
(10) Pub. No.: US 2026/0107168 A1
(43) Pub. Date: Apr. 16, 2026

(54) METHOD AND WI-FI CONNECTIVITY DIAGNOSTIC DEVICE FOR CAPTURE AND ANALYSIS OF WI-FI PACKET TRAFFIC DURING CLIENT ROAMING EVENTS

(71) Applicant: Sidos Systems Oy, Helsinki (FI)

(72) Inventor: Mika Hakala, Arlington, VA (US)

(73) Assignee: Sidos Systems Oy, Helsinki (FI)

(21) Appl. No.: 18/916,009

(22) Filed: Oct. 15, 2024

(51) Int. Cl. H04W 24/08; H04W 24/06; H04W 84/12

(52) U.S. Cl. CPC H04W 24/08; H04W 24/06; H04W 84/12

(57) ABSTRACT

A method and a Wi-Fi connectivity diagnostic device for effectively capturing and analyzing Wi-Fi packet traffic during client roaming events across wireless channels includes periodically scanning, by the Wi-Fi connectivity diagnostic device, Wi-Fi channels in the building to identify Wi-Fi client devices and access points; detecting roaming criteria including signal strength and network parameters to determine potential channels to which the Wi-Fi client devices may roam; capturing, by one or more first radios of the Wi-Fi connectivity diagnostic device, packet traffic originating from and terminating at the Wi-Fi client device on its current channel; capturing, by one or more second radios of the Wi-Fi connectivity diagnostic device, packet traffic on an expected next channel to which the Wi-Fi client device is likely to roam; detecting a user-defined problem event; and mapping the detected problem event to a three-dimensional representation of the environment of the building.

### TECHNICAL FIELD

The present disclosure relates to Wireless Local Area Network (WLAN or Wi-Fi) connectivity analysis and troubleshooting. The present disclosure also relates to a method and a Wi-Fi connectivity diagnostic device to effectively capture and analyze Wi-Fi packet traffic during client roaming events across different wireless channels.

### BACKGROUND

Wi-Fi connectivity troubleshooting, especially during client roaming events, presents significant challenges as troubleshooting requires an effective strategy to capture and analyze Wi-Fi packet traffic across multiple channels. Currently, Wi-Fi connectivity troubleshooting involves various manual tools and techniques. These may include layer-specific tools such as physical layer tools that focus on Radio Frequency (RF) signal strength and interference and link layer tools that focus on packet-level issues such as physical address, packet retransmission, loss, and collisions. The layer-specific nature of the tools may require manual diagnosis of issues occurring across multiple layers. This is not optimal since a user needs to figure out the issue regardless of a layer that may be causing it. Furthermore, the issue may be associated with multiple layers whereby issues in a layer causes issues in another layer. The layer-specific nature of the tools may be problematic as issues at the physical layer such as signal interference can impact performance of the link layer in terms of packet loss or retransmissions. In such scenarios, a holistic tool that integrates both layers would be more effective in diagnosing and resolving connectivity issues.

Packet capture using an electronic device (such as a laptop) having a single radio terminal is inefficient for monitoring multiple channels and creates configuration challenges. To enhance the efficiency of packet capture and find solutions for the challenges, additional Wi-Fi adapters (such as those available commercially as Universal Serial Bus (USB) network adapter sticks) are used. However, a setup with multiple Wi-Fi adapters is cumbersome and may not be scalable. Additionally, packet capture involves configuring packet capture tools to monitor specific channels beforehand. The specific channels are selected by the access points and Wi-Fi clients and those channel selections are not visible or available to the user. After the configuration of the packet capture tools, packet capture is started. The hidden process of channel selection often results in missing critical roaming events due to inability to capture all channels simultaneously.

During roaming events, it is necessary to capture traffic on a current channel used by a client device and one or more target channels to which the client device is likely to roam. Without precise information specifying channels that are required to be monitored, crucial or critical packets may be missed, leading to difficulty in diagnosing and resolving roaming issues effectively. When many channels are randomly selected for monitoring (due to lack of information specifying the channels to be monitored), size of a capture file may grow quicky during packet capture. This is because traffic at each of the randomly selected channels may be high. The traffic at a selected channel may include traffic that is of interest and other traffic that is of no importance. Thus, the packet capture process leads to obtaining a capture file that includes significant irrelevant traffic. This necessitates extensive post-capture filtering of the capture file. Furthermore, the user chosen set of channels to scan may not include the channel where the roaming client decides to move to, and in such case the packet capture for the full roaming event fails.

Therefore, to identify issues that may be leading to failure in the client device roaming from one access point to another, having access to precise information specifying the channels required to be monitored for packet capture is non-trivial. Since it is infeasible to capture all channels (due to increase in size of capture file during packet capture and technical restrictions of having sufficient amount of concurrently operating Wi-Fi network adapters), it is necessary to determine the precise information specifying the channels required to be monitored. The determination may be a significant challenge.

In summary, the current approach to Wi-Fi connectivity troubleshooting is marred by challenges such as lack of integrated tools that focus on issues related to both physical and link layers, inefficient multi-channel packet capture methods, and the impracticality of monitoring all potential channels during client roaming events. Addressing these shortcomings would require developing more advanced, integrated diagnostic tools and more efficient, scalable methods for multi-channel packet capture.

Therefore, considering the foregoing discussion, there exists a need to overcome the aforementioned drawbacks.

### SUMMARY

The aim of the present disclosure is to provide a computer-implemented method, a Wi-Fi connectivity diagnostic device, a system, a computer program for Wi-Fi connectivity diagnostics in a building, and a computer program product for Wi-Fi connectivity diagnostics in a building for effectively capturing and analyzing Wi-Fi packet traffic during client roaming events across different wireless channels. The Wi-Fi connectivity diagnostic device includes one or more radios that are configured to capture packet traffic on a current channel to which a Wi-Fi client device is connected, capture packet traffic on an expected next channel to which the Wi-Fi client device may roam to and perform automated channel scanning. Additionally, irrelevant capture data, which was collected during packet data capture, can be promptly deleted. A user-defined problem event is detected, and data captured prior to and after the detection of the user-defined problem event can be preserved for further analysis. Finally, the detected problem event is mapped to a three-dimensional representation of an environment in which the Wi-Fi client device is located. The aim of the present disclosure is achieved by usage of the provided method, the Wi-Fi connectivity diagnostic device, the system, the computer program, and the computer program product for effectively capturing and analyzing Wi-Fi packet traffic as defined in the appended independent claims to which reference is made to. Advantageous features are set out in the appended dependent claims.

### BRIEF DESCRIPTION OF THE DRAWINGS

FIG. 1 illustrates an overlaying of problem events, detected by a Wireless-Fidelity (Wi-Fi) client device, on a floorplan and capturing of packet data associated with candidate channels to which the Wi-Fi client device may roam, according to an embodiment of the present disclosure;

FIG. 2 illustrates a set of roaming decisions made by a Wi-Fi client device as it navigates through an environment of a building, in accordance with an embodiment of the present disclosure;

FIG. 3 illustrates exemplary interactions between a Wi-Fi client device and access points, according to an embodiment of the present disclosure;

FIG. 4 illustrates steps of a method for Wi-Fi connectivity diagnostic in a building, in accordance with an embodiment of the present disclosure;

FIG. 5 illustrates a schematic diagram of a Wi-Fi connectivity diagnostic device, in accordance with an embodiment of the present disclosure; and

FIG. 6 illustrates a schematic diagram of a system for Wi-Fi connectivity diagnostics in a building, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for Wi-Fi connectivity diagnostic in a building, the method comprises: periodically scanning, by a Wi-Fi connectivity diagnostic device, Wi-Fi channels in the building to identify Wi-Fi client devices and access points on their current channels; detecting roaming criteria including signal strength and network parameters to determine potential channels to which the Wi-Fi client devices may roam; capturing, by one or more first radios of the Wi-Fi connectivity diagnostic device, packet traffic originating from and terminating at the Wi-Fi client device on its current channel; capturing, by one or more second radios of the Wi-Fi connectivity diagnostic device, packet traffic on an expected next channel to which the Wi-Fi client device is likely to roam; detecting a user-defined problem event; mapping the detected problem event to a three-dimensional (X, Y, Z) representation of the environment of the building.

In a second aspect, the present disclosure provides a Wi-Fi connectivity diagnostic device, the Wi-Fi connectivity diagnostic device comprising: one or more first radios configured to capture packet traffic on the current channel of a Wi-Fi client device; one or more second radios configured to capture packet traffic on an expected next channel to which the Wi-Fi client device may roam; a scanning module configured for automated channel scanning; signal strength sensors configured for proximity measurements using received signal strength indicator (RSSI); a predictive monitoring module configured to determine potential future channels based on historical data and machine learning algorithms; an event button configured to allow user-initiated detection of problem event occurrences; a spatial mapping module configured to map captured events to a three-dimensional (X, Y, Z) representation of the environment of the building.

In a third aspect, the present disclosure provides a system for Wi-Fi connectivity diagnostics in a building, the system comprises: a Wi-Fi connectivity diagnostic device comprising one or more first radios configured to capture packet traffic on the current channel of a Wi-Fi client device; one or more second radios configured to capture packet traffic on an expected next channel where the Wi-Fi client device may roam; optionally, one or more third radios configured to periodically scan channels in the building to identify Wi-Fi client devices and access points and update potential roaming channels; a processor configured to: control the operation of the multiple radios, analyze roaming criteria including signal strength and network parameters, predict potential channels to which the Wi-Fi client device may roam, detect problem events, and map detected problem events to a spatial floorplan of the building; a memory configured to: store captured packet traffic originating from and terminating at the Wi-Fi client device, retain data for predetermined periods around the detection of problem events, save signal strength measurements and network parameters, and maintain time stamps for recorded data; and a user interface, comprising: a button configured to allow a user to indicate the occurrence of a problem event, and an interface to display or output diagnostic information and spatial maps.

In a fourth aspect, the present disclosure provides a computer program for Wi-Fi connectivity diagnostics in a building, the computer program comprising instructions which, when executed by a processor, cause a Wi-Fi connectivity diagnostic device to carry out the method provided by the present disclosure in the first aspect.

In a fifth aspect, the present disclosure provides a computer program product for Wi-Fi connectivity diagnostics in a building, the computer program product comprising a non-transitory computer-readable medium having stored thereon a program code, the program code comprising instructions which, when executed by a processor, cause a Wi-Fi connectivity diagnostic device to carry out the method provided by the present disclosure in the first aspect.

The embodiments of the present disclosure enable to utilize one or more radios in the Wi-Fi diagnostic device to capture packet traffic associated with a current channel on which a Wi-Fi client device is currently operating on and through which the Wi-Fi client device is currently communicating with other Wi-Fi client devices in a Wi-Fi network, capture packet traffic associated with a channel to which the Wi-Fi client device is subsequently expected to roam to after disconnecting from the current channel, and scan all available channels to automate channel selection and increase a likelihood of successfully roaming by capturing/selecting an optimal channel. To achieve the above, the Wi-Fi diagnostic device may determine other Wi-Fi client devices and access points in proximity of the Wi-Fi client device, and measure signal strength and determine network parameters associated with the other Wi-Fi client devices and the access points, Wi-Fi client devices and access points of interest. The determination of other Wi-Fi client devices and access points in the proximity of the Wi-Fi client device and measurement of signal strength and network parameters allows determining Wi-Fi client devices that are required to be tracked and access points of interest. In addition, this allows filtering irrelevant data captured during scanning and monitoring of the available channels and determine an optimal channel that is required to be monitored such that the Wi-Fi client device may roam to the optimal channel on detection of an event that is indicative of interruption of Wi-Fi connectivity of the Wi-Fi client device.

The method is operable to periodically scan operational Wi-Fi channels in the building through which data communication may take place between the Wi-Fi client device and other Wi-Fi client devices/access points. The scanning may be performed by controlling one or more radios of the Wi-Fi connectivity diagnostic device to identify other Wi-Fi client devices and access points that are in vicinity of the client Wi-Fi device. In accordance with an embodiment, the Wi-Fi connectivity diagnostic device may include at least three radios. Once the other Wi-Fi client devices and the access points in the vicinity of the Wi-Fi client device is identified, the Wi-Fi connectivity diagnostic device may be positioned near the other Wi-Fi client devices and the access points. The Wi-Fi connectivity diagnostic device may be positioned near the other Wi-Fi client devices and access points while the Wi-Fi client device may continue to perform normal operation(s). In this setup, attempts may be made to reproduce an issue that needs to be troubleshooted.

The method is further operable to detect roaming criteria. This includes determination of signal strength and network parameters to determine potential channels to which the Wi-Fi client devices may roam. When the Wi-Fi connectivity diagnostic device may be positioned near the other Wi-Fi client devices, the determined signal strength may be used to determine other client Wi-Fi devices that is required to be tracked. Similarly, based on the determined signal strength access points of interest may be determined. The determination of the other Wi-Fi client devices and the access points of interest also include determination of their Media Access Control (MAC) addresses.

Optionally, the method further comprises filtering captured data based on MAC addresses. Based on the determined MAC addresses, a massive amount of irrelevant traffic, captured during the monitoring of channels connecting the Wi-Fi client with the other Wi-Fi client devices and access points, can be filtered. More importantly, using the MAC addresses, smart decisions relevant to selection of channels to be monitored using the one or more radios (the at least three radios, for example) of the Wi-Fi connectivity diagnostic device may be made.

The method is further operable to capture packet traffic originating from and terminating at the Wi-Fi client device on the current channel to which the Wi-Fi client device is connected. The packet traffic is captured using one or more first radios of the Wi-Fi connectivity diagnostic device. The Wi-Fi connectivity diagnostic device may use one of the radios to monitor the current channel, on which the Wi-Fi client device is communicating, at all times and capture all traffic originating and terminating at the Wi-Fi client device. The method is further operable to capture packet traffic on another channel to which the Wi-Fi client device is subsequently likely to roam. The packet traffic on the other channel is captured using one or more second radios of the Wi-Fi connectivity diagnostic device.

A roaming process based on which the Wi-Fi client device roams to the other channel and information that triggers the client device to roam to the other channel is usually proprietary. Thus, determination of when or to which channel the client Wi-Fi device is likely to roam to is ambiguous. However, signal strength, data rate capabilities, channel width, and an availability of an access point to provide services are some of the factors based on which the Wi-Fi client device may determine a channel to which to roam and an instant at which to roam. Thus, the Wi-Fi connectivity diagnostic device may be operable to use the one or more second radios to monitor packet traffic at the channel to which the Wi-Fi client device will roam.

In accordance with an embodiment, the at least three radios of the Wi-Fi connectivity diagnostic device may be used such that a first radio is used to capture the channel using which the Wi-Fi client device is currently communicating. The Wi-Fi connectivity diagnostic device may determine whether the Wi-Fi client device has left the current channel based on a detection of absence of transmissions from the MAC of the Wi-Fi client device or detecting transmissions from the MAC of the Wi-Fi client device on some other channel. A second radio is used to capture a channel where the Wi-Fi client device roams to when the Wi-Fi client device leaves the current channel. A third radio is used to increase a probability of detecting the Wi-Fi client device after the Wi-Fi client device leaves the current channel and facilitating the Wi-Fi client device to roam to a candidate channel which may not be the best candidate channel to roam to.

Optionally, the method is further operable to scan the channels by one or more third radios to determine new potential roaming candidates. In some embodiments, the third radio is used to scan all channels to generate or update a list of potential candidate channels to which the Wi-Fi client device may roam to. The Wi-Fi client device may select a candidate channel from the list of potential candidate channels.

In accordance with an embodiment, the channels to be included in the list of potential candidate channels may be selected by scanning the environment of the building in real-time for detection of all available networks and simulating a roaming decision of the Wi-Fi client device whereby target candidate channels to which the Wi-Fi client device is likely to roam is determined. The selection of the candidate channels to be included in the list of potential candidate channels may also based on apriori information of the environment of the building. The apriori information is obtained based on performing network measurements in the environment prior to packet capture.

Optionally, the method further comprises using a pre-constructed digital model of the Wi-Fi network environment and/or previous measurements of the building to predict what is the expected next channel where a Wi-Fi client device could roam to. The network measurements may be fed to the digital model overlaying a physical floor plan image of the building. Furthermore, locations of the Wi-Fi client device may be determined as the Wi-Fi client device traverses the physical floor plan and as the network measurements are performed. The locations may be fed to the digital model. Based on the determined locations and the network measurements fed to the digital model, the list of candidate channels or potential channels, which are ideal for the Wi-Fi client device to roam, may be determined.

The pre-constructed digital model of a Wi-Fi network environment (i.e., the radio environment of the building) may comprise a layout of the building, locations and channels of access points, and signal strength patterns throughout the layout of the building. The layout of the building includes detailed floor plans including walls, rooms, and any physical obstructions that could affect signal propagation. The locations and channels of the access points include exact positions of all access points and the channels the access points operate on. The signal strength patterns may include measurements of signal strength at various locations throughout the building. The measurements may be used to map how the Wi-Fi signals propagate at various locations throughout the building.

The pre-constructed digital model includes measurements of all networks in the Wi-Fi network environment, a measured ‘map’ of radio signals in the Wi-Fi network environment, a physical floorplan of the building, information of location of the Wi-Fi client devices and Wi-Fi access points, and problem events on the physical floorplan.

Additionally, the pre-constructed digital model also comprises material properties data, network traffic data, device density and locations, interference sources, historical roaming data, environmental factors, security settings, and firmware and configuration details. The material properties data includes information about materials of walls and other barriers (such as concrete, glass, and so on) in the building that may cause signal attenuation. The network traffic data includes patterns of network usage and markers for identifying areas of high traffic and low traffic. The device density and locations include expected or actual positions of Wi-Fi client devices (such as laptops, smartphones, and so on) at different times of a day. The interference sources include locations and types of potential sources of interference (such as microwave ovens, other wireless devices, and so on). The historical roaming data includes previous patterns of Wi-Fi client devices roaming between access points. The historical roaming data allows predicting channels to which the Wi-Fi client device may roam in the future. The environmental factors include information related to environmental conditions that might affect propagation of Wi-Fi signals. The environmental conditions include temperature, humidity levels, wind speed, and so on. The security settings include information on encryption methods and security protocols that are used in the Wi-Fi network. The firmware and configuration details may include versions of firmware and specific configurations of the access points that could impact performance (such as throughput).

Thus, the Wi-Fi connectivity diagnostic device may include three radios that can be operated such that three different channels are scanned simultaneously.

Optionally, the method further comprises automatically adjusting scanning and capturing frequencies based on detected network activity to optimize data collection efficiency. The Wi-Fi connectivity diagnostic device is likely to detect a new candidate channel for the Wi-Fi client device to roam to. The detection of the new candidate channel is faster than that of the Wi-Fi client device (which performs periodically scanning only).

Optionally, the method further comprises predicting what is the expected next channel for Wi-Fi client device likely to roam using historical data and machine learning algorithms. Furthermore, the Wi-Fi connectivity diagnostic device may use information that states that the Wi-Fi client device may roam to a certain candidate channel when the Wi-Fi client device finds the candidate channel through scanning. By roaming to the candidate channel, it is possible for the Wi-Fi client device to receive a stronger or otherwise higher quality signal.

The Wi-Fi connectivity diagnostic device uses the information to make predictions indicating the candidate channel prior to the Wi-Fi client device actually detecting the stronger signal and roaming to the candidate channel. The prediction may be made using the digital model.

Optionally, the method further comprises analyzing signal strength trends over time to refine the predictions. Furthermore, the Wi-Fi connectivity diagnostic device may use the digital model and the apriori information to determine a location where a stronger signal may be detected. The determination may take place even before the stronger signal is detected through real-time measurement. Thus, by using the three radios of the Wi-Fi connectivity diagnostic device simultaneously and the digital model of the Wi-Fi connectivity diagnostic device, the probability of using one of the three radios to successfully capture the channel to which the Wi-Fi client device will subsequently roam is significantly increased.

The method is further operable to detect a user-defined problem event. A problem event associated with roaming and connectivity issue of the Wi-Fi client device may occur randomly. It is necessary to track the channel on which the Wi-Fi client device is communicating at all times and capture all traffic originating and terminating at the Wi-Fi client device until the same problem event reoccurs. It is also necessary that the packet capture was taking place on the right channels (i.e., the channels to which the Wi-Fi client device may roam to) at the time of occurrence of the problem event. For tracking the current channel and ensuring that packet capture is taking place on the right channels, the Wi-Fi connectivity diagnostic device may capture relevant traffic on all channels continuously. Since relevant traffic on all the channels is captured, the amount of captured data is massive. Most of the captured data is irrelevant and was captured when the problem event did not occur. Therefore, such data needs to be deleted after a predefined period (such as “n” minutes after capture).

Optionally, detecting the problem event comprises a user-initiated detection via a button on the Wi-Fi connectivity diagnostic device and recording data for a predetermined period of time before and after the user presses the button to indicate the occurrence of the problem event, and wherein the recorded data comprises packet traffic captured by the first and second radios, signal strength measurements, network parameters, and time stamps of the captured data. For storing relevant data that was captured from a first instant prior to the detection of the problem event to a second instant after the detection of the problem event, a button may be required to be pressed. The button may be included in the Wi-Fi connectivity diagnostic device. The problem event is detected when the button is pressed. A user may press the button when he/she detects that the problem event has occurred. Such pressing of the button may lead to storage of the captured data from the first instant to the second instant. The first instant may be “n” minutes prior to pressing the button and the “n” minutes after pressing of the button. The data captured prior to the first instant and after the second instant is deemed irrelevant and may be deleted.

In some embodiments, the problem event may be detected and storage of the data captured between the first instant and the second instant may be triggered based on a pre-defined rule. A pre-defined rule may be a part of a software of the Wi-Fi connectivity diagnostic device. This would come into question, for example, with warehouse robots. The operators of the warehouse robots encounter issues when they drive the warehouse robots around the warehouse. The issues may occur at instances when a Wi-Fi connection with a warehouse robot fails, and the warehouse robot stops moving. Detecting the issue may be challenging as the warehouse robot has already stopped and the connection has been broken. In such scenarios, the Wi-Fi connectivity diagnostic device may be positioned at a side on the warehouse robot, and the software of the Wi-Fi connectivity diagnostic device may cause the detection of the issue and trigger the storage of captured data.

The method is further operable to map the detected problem event to a three-dimensional (X, Y, Z) representation of the environment of the building. The detected problem event may be overlaid onto a floorplan (X, Y, Z coordinates) of the building. This includes determining a location of the Wi-Fi client device when the problem event is detected in the Wi-Fi client device. In addition, a time stamp of detection of the problem event may be recorded. Mapping the detected problem event onto the floorplan may aid in understanding of the problem event. For example, based on the mapping it may be determined whether the problem event occurs at the same part of the building or whether the problem event occurs randomly and has no correlation in terms of its occurrence at one or more locations. The mapping allows predicting a candidate channel where the Wi-Fi client device is expected to the roam and a location when the roaming may take place.

Optionally, the method further comprises correlating detected problem events with environmental changes such as physical obstructions or interference sources to improve troubleshooting accuracy. Mapping detected problem events to a spatial floorplan of the building can be performed either immediately in the Wi-Fi connectivity diagnostic device or later in a cloud. In both scenarios, the Wi-Fi connectivity diagnostic device is required to collect Received Signal Strength indicator (RSSI) and other data on the basis of which positioning may be determined.

In an embodiment, the location of the Wi-Fi client device at a time instance of detection of the problem event or pressing of the button can be obtained from the user or automatically determined based on the signals measured at the instance of pressing of the button. The signal data may be matching to a pre-constructed model of the building. The mapping may use triangulation, Global Positioning System (GPS), finger printing, or any other indoor location determination technique.

The present disclosure also relates to the second aspect as described above. Various embodiments and variants disclosed above, with respect to the aforementioned first aspect, apply mutatis mutandis to the second aspect.

Optionally, the Wi-Fi connectivity diagnostic device further comprises one or more third radios configured to periodically scan Wi-Fi channels to identify new potential roaming candidates and update the predictive monitoring module with real-time data.

The Wi-Fi connectivity diagnostic device may be positioned near a Wi-Fi client device, other Wi-Fi client devices, and access points in the building to determine MAC addresses of the Wi-Fi client device, other Wi-Fi client devices that are to be tracked, and relevant access points. Signal strength (a physical layer parameter) at the Wi-Fi client device, each of the other Wi-Fi client devices, and each of the access points is used to determine the MAC addresses (a data link parameter). Thus, an integrated tool for checking issues associated with the physical layer and the data link parameter is provided.

The inclusion of at least three radios in the Wi-Fi connectivity diagnostic device allows capturing packet traffic on the current channel, capturing packet traffic on an expected next channel to which the Wi-Fi client device may roam, and capturing a set of candidate channels where the Wi-Fi client device is most likely to roam to. The set of candidate channels is determined by scanning all channels. The set of candidate channels can be used for simulating a scenario where a problem event related to roaming is detected and a decision is made by the Wi-Fi client device to roam to a candidate channel after scanning the environment.

In accordance with an embodiment, a pre-constructed digital twin model of the radio network may be used to estimate, or increase the likelihood of estimating, the potential roaming candidate channels.

The introduction of the button in the Wi-Fi connectivity diagnostic device allows a user to indicate an instance when a problem event had occurred. This will allow deleting or discarding data that was captured when the problem event was not detected and, thereby, allow saving storage space.

The present disclosure also relates to the third aspect as described above. Various embodiments and variants disclosed above, with respect to the aforementioned first aspect, apply mutatis mutandis to the third aspect.

Optionally, the system further comprises an adjustable antenna array configured to dynamically adjust its orientation and/or configuration and signal focus to optimize the reception and capture of Wi-Fi signals based on the detected roaming criteria and current network conditions.

The present disclosure also relates to the fourth aspect as described above. Various embodiments and variants disclosed above, with respect to the aforementioned first aspect, apply mutatis mutandis to the fourth aspect.

The present disclosure also relates to the fifth aspect as described above. Various embodiments and variants disclosed above, with respect to the aforementioned third aspect, apply mutatis mutandis to the fifth aspect.

### DETAILED DESCRIPTION OF THE DRAWINGS

Referring to FIG. 1, there is illustrated an overlaying of problem events, detected by a Wi-Fi client device, on a floorplan 100 and capturing of packet data associated with candidate channels to which the Wi-Fi client device may roam, according to an embodiment of the present disclosure. The problem events may include a loss of connectivity between the Wi-Fi client device and an access point, halt in transmission of data from the Wi-Fi client device, or halt in reception of data to the Wi-Fi client device. The detection of the problem events may lead to the Wi-Fi client device roaming to another channel that connects the Wi-Fi client device to an access-point. As shown in FIG. 1, a three-dimensional representation of an environment, i.e., the floorplan 100, of a building may include the Wi-Fi client device. The Wi-Fi client device passes through a set of locations 102A-102D within the building. The set of locations may include a first location 102A (labelled as ‘1’), a second location 102B (labelled as ‘2’), a third location 102C (labelled as ‘3’), and a fourth location 102D (labelled as ‘4’). The floorplan 100 further shows physical obstructions (walls, for example) and a set of access points 104A-104D. The set of access points 104A-104D include a first access point 104A (labelled as ‘AP1’), a second access point 104B (labelled as ‘AP2’), a third access point 104C (labelled as ‘AP3’), and a fourth access point 104D (labelled as ‘AP4’). Each access point of the set of access points 104A-104D is an access point of interest for the Wi-Fi client device.

Initially, the Wi-Fi client device may be at the first location 102A. At this stage, the strength of a signal received from the third access point 104C is the highest. Therefore, the Wi-Fi client device is connected to the third access point 104C. When the Wi-Fi client device is at the second location 102B, the strength of a signal received from the second access point 104B is the highest. Therefore, the Wi-Fi client device roams from a channel connecting the Wi-Fi client device with the third access point 104C to another channel connecting the Wi-Fi client device with the second access point 104B. It may be noted that at the second location 102B, the strength of a signal received from the first access point 104A is not as strong as the strength of the signal received from the second access point 104B even as the Wi-Fi client device is closer to the first access point 104A. This is because the Wi-Fi client device is shadowed by the wall “A”.

When the Wi-Fi client device is at the third location 102C, there is a line-of-sight connection between the Wi-Fi client device and the first access point 104A. The line-of-sight connection allows the Wi-Fi client device to detect that the strength of a signal received from the first access point 104A is greater compared to strength of the signal received from the second access point 104B to which the Wi-Fi client device is currently connected to. Depending on an internal logic configured in the Wi-Fi client device, the Wi-Fi client device may or may not roam from the second access point 104B to the first access point 104A. When the Wi-Fi client device is at the fourth location 102D, the strength of a signal received from the second access point 104B is the highest. Thus, the Wi-Fi client device may roam to a channel connecting the the Wi-Fi client device to the second access point 104B (if the Wi-Fi client device is not already connected to the second access point 104B).

The Wi-Fi client device may make decisions to roam to other access points based on real time measurements of strengths of signals received from different access points, if the Wi-Fi client device does not have access to apriori information. For example, at the second location 102B, it would be optimal to remain connected to a channel connecting the Wi-Fi client device to the third access point 104C then to roam to a channel that connects the Wi-Fi client device to the first access point 104A. The Wi-Fi client device may roam to the channel connecting to the first access point 104B as the Wi-Fi client device does not have the apriori information.

In this scenario, a Wi-Fi connectivity diagnostic device with a set of radios may measure the strengths of the signals from all access points of the set of access points 104A-104D earlier than the Wi-Fi client device. If the the Wi-Fi client device is at the second location 102B (or approaching the second location 102B), and if the Wi-Fi client device is unable to determine whether it is advantageous to remain connected to the third access point 104C or roam to a channel connecting to the first access point 104A or the second access point 104B, then the apriori information may be used to initiate scanning for channels that connect to the first access point 104A or the second access point 104B as the Wi-Fi client device approaches the third location 102C. This will ensure that the Wi-Fi connectivity diagnostic device will capture a roaming event, since at least one radio of the Wi-Fi connectivity diagnostic device is on both possible candidate roaming channels where the Wi-Fi client device may roam to. Alternatively, three radios of the Wi-Fi connectivity diagnostic device will be used to scan all channels on which the first access point 104A, the second access point 104B, and the third access point 104C operate on simultaneously. In the roaming event, the Wi-Fi client device will roam to a channel connecting to the second access point 104B and Wi-Fi connectivity diagnostic device will already have at least one radio on the same channel using the apriori information.

For example, the floorplan 100 may include any number of access points, a layout of the floorplan 100 may be different from the one as shown in FIG. 1, and a trajectory followed by the Wi-Fi client device may be different from the one as shown in FIG. 1.

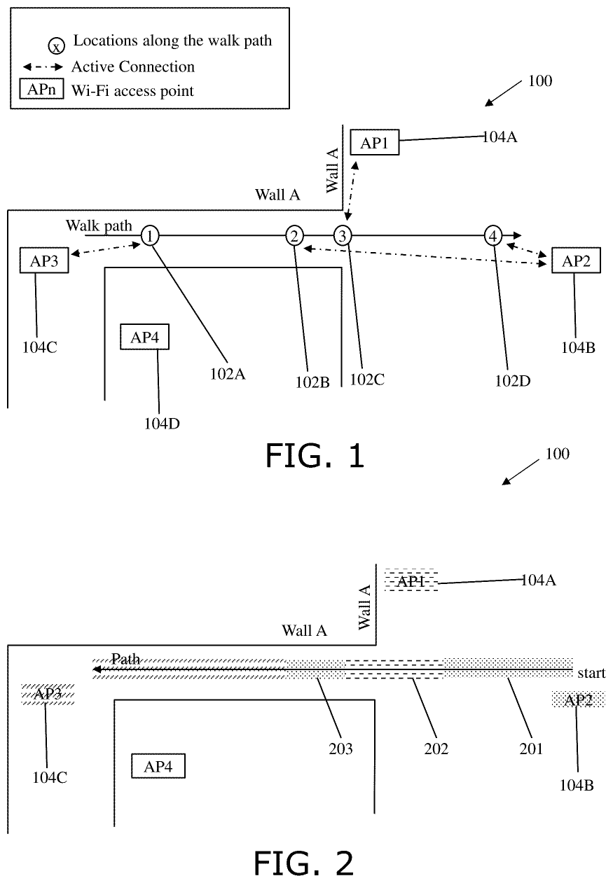

Referring to FIG. 2, there is illustrated a set of roaming decisions made by a Wi-Fi client device as it navigates through an environment of a building, in accordance with an embodiment of the present disclosure. The environment shown in FIG. 2 is the same as that shown in FIG. 1, but the same path has shown in the opposite direction. As shown in FIG. 2, the Wi-Fi client device may traverse a path in the environment whereby the Wi-Fi client device is initially at the second location 102B and finally at the third location 102C.

The Wi-Fi client device is connected to the second access point 104B through a channel when the Wi-Fi client device is at the second location 102B. The Wi-Fi client device may continue to remain connected to the second access point 104B until the Wi-Fi client device traverses a first distance 201. The Wi-Fi connectivity diagnostic device may scan all functional channels in the environment and determine that the floorplan 100 includes the set of access points 104A-104D. The Wi-Fi connectivity diagnostic device may be positioned near each access point of the set of access points 104A-104D to determine MAC addresses of each access point and strengths of signals. One or more first radios of the Wi-Fi connectivity diagnostic device is used to capture packet traffic, originating from, and terminating at the Wi-Fi client device, associated with the channel through which the Wi-Fi client device is connected to the second access point 104B. One or more second radios of the Wi-Fi connectivity diagnostic device is used to capture packet traffic on an expected next channel to which the Wi-Fi client device is likely to roam. The expected next channel is a channel that may connect the Wi-Fi client device to the first access point 104A. Furthermore, one or more third radios of the Wi-Fi connectivity diagnostic device is used to continuously (i.e., an entire period during which the Wi-Fi client device traverses a path) scan other channels in the environment to determine new potential candidate channels to which the Wi-Fi client device may roam to.

After traversing the first distance 201, the Wi-Fi client device roams to a channel that connects the Wi-Fi client device to the first access point 104A. The roaming may take place when the Wi-Fi client device detects a first problem event during its own scanning process. The Wi-Fi client device may continue to remain connected to the first access point 104A until the Wi-Fi client device traverses a second distance 202. One or more first radios of the Wi-Fi connectivity diagnostic device is used to capture packet traffic, originating from and terminating at the Wi-Fi client device, associated with the channel through which the Wi-Fi client device is connected to the first access point 104A. One or more second radios of the Wi-Fi connectivity diagnostic device is used to capture packet traffic on an expected next channel to which the Wi-Fi client device is likely to roam. The expected next channel is a channel that may connect the Wi-Fi client device to the second access point 104B.

After traversing the second distance 202, the Wi-Fi client device roams to the channel that connects the Wi-Fi client device to the second access point 104B. The roaming may take place when the Wi-Fi client device detects a second problem event during its own scanning process. The Wi-Fi client device may continue to remain connected to the second access point 104B until the Wi-Fi client device traverses a third distance 203. One or more first radios of the Wi-Fi connectivity diagnostic device is used to capture packet traffic, originating from and terminating at the Wi-Fi client device, associated with the channel through which the Wi-Fi client device is connected to the second access point 104B. One or more second radios of the Wi-Fi connectivity diagnostic device is used to capture packet traffic on an expected next channel to which the Wi-Fi client device is likely to roam. The expected next channel is a channel that may connect the Wi-Fi client device to the third access point 104C. After traversing the third distance 203, the Wi-Fi client device roams to the channel that connects the Wi-Fi client device to the third access point 104C. The roaming may take place when the Wi-Fi client device detects a third problem event during its own scanning process.

In accordance with an embodiment, the Wi-Fi connectivity diagnostic device may use apriori information that comprises previously measured strengths of signals received from various access points of the set of access points 104A-104D at various locations on the path. Based on the apriori information, the Wi-Fi connectivity diagnostic device may roam to an optimal channel at a particular location on the path where the Wi-Fi client device is situated before the Wi-Fi client device performs such roaming. By roaming to the optimal channel, the Wi-Fi client device can connect to the access point from the set of access points 104A-104D that offers the strongest signal. The strength of a signal received on the channel is highest compared to strengths of other signals received from other access points of the set of access points 104A-104D. The usage of the apriori information facilitates faster roaming to the optimal channel compared to a scenario where the Wi-Fi connectivity diagnostic device would be required to measure strengths of signals received from multiple access points in real-time before selecting the optimal channel to roam to. The faster roaming allows the Wi-Fi connectivity diagnostic device to release one of its three radios from capturing packet traffic on a channel to which the Wi-Fi client device is not likely to connect in the future. The freed radio may be used for capturing packet traffic on a channel to which the Wi-Fi client device may roam to. The Wi-Fi connectivity diagnostic device may initiate capturing the packet traffic on the channel prior to the Wi-Fi client device determining about the requirement to roam to the channel. More specifically, the Wi-Fi connectivity diagnostic device is configured to go to the right channel before the client device makes its own corresponding decision.

It is to be noted that the Wi-Fi connectivity diagnostic device can also perform real-time scanning and select an optimum candidate channel where the Wi-Fi client device is expected to roam to. However, usage of apriori information can facilitate faster roaming and increased likelihood of setting a radio of the Wi-Fi connectivity diagnostic device for capturing a channel where the Wi-Fi client is likely to roam to in the future.

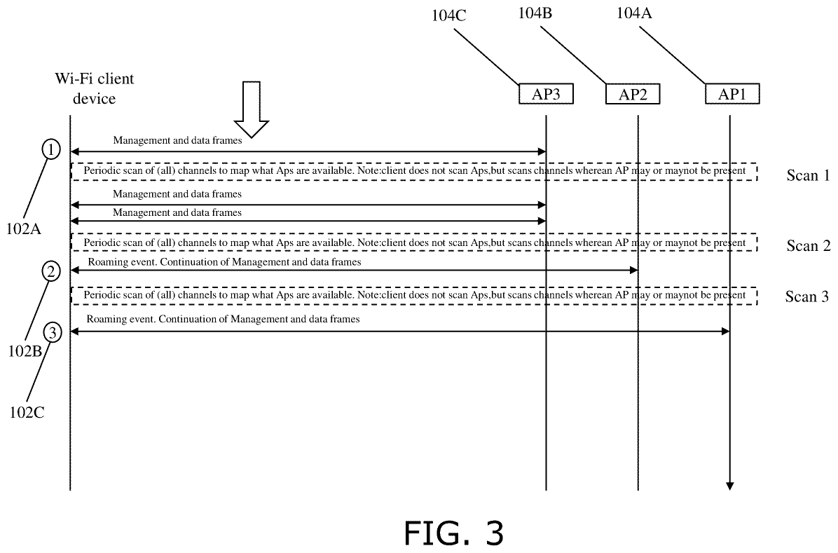

Referring to FIG. 3, there is illustrated exemplary interactions between a Wi-Fi client device and access points, in accordance with an embodiment of the present disclosure. The access points include the first access point 104A, the second access point 104B, and the third access point 104C. The Wi-Fi client device interacts with the access points as the Wi-Fi client devices traverses through the first location 102A, the second location 102B, and the third location 102C. Initially, the Wi-Fi client device is connected to the third access point 104C. Management and data frames may be exchanged using a channel connecting the Wi-Fi client device and the third access point 104C. The Wi-Fi connectivity diagnostic device may use at least three radios to listen to link layer information exchange between the Wi-Fi client device and the third access point 104C. The listening requires that a radio be capturing the channel connecting the Wi-Fi client device and the third access point 104C. The Wi-Fi client device may perform a first scan (scan-1) to check all channels in the environment. The Wi-Fi client device periodically scans Wi-Fi channels in the environment to identify access points. At this stage, the Wi-Fi client device does not detect a signal from another access point that is having a greater strength compared to that of a signal received from the third access point 104C.

When the Wi-Fi client device performs a second scan (scan-2), it is determined that strength of a signal received from the second access point 104B is higher than the strength of the signal received from the third access point 104C. Based on the determination, the Wi-Fi client device may roam to a channel connecting the Wi-Fi client device to the second access point 104B. The roaming takes place when the Wi-Fi client device is at the second location 102B. After the roaming, management and data frames may be exchanged using the channel connecting the Wi-Fi client device and the second access point 104B.

When the Wi-Fi client device performs a third scan (scan-3), it is determined that strength of a signal received from the first access point 104A is higher than the strength of the signal received from the second access point 104B. Based on the determination, the Wi-Fi client device may roam to a channel connecting the Wi-Fi client device to the first access point 104A. The roaming takes place when the Wi-Fi client device is at the third location 102C. After the roaming, management and data frames may be exchanged using the channel connecting the Wi-Fi client device and the first access point 104A.

It is to be noted that although the signal strength may not be the only roaming criteria, it has a significant weight in a decision to roam to another channel from a current channel. The Wi-Fi client device can also detect other characteristics that may or may not be used in the decision to roam.

Referring to FIG. 4, there is illustrated steps of a method 400 for Wi-Fi connectivity diagnostic in a building, in accordance with an embodiment of the present disclosure. At step 402, the method includes periodically scanning, by a Wi-Fi connectivity diagnostic device, Wi-Fi channels in the building to identify Wi-Fi client devices and access points on their current channels. At step 404, the method includes detecting roaming criteria including signal strength and network parameters to determine potential channels to which the Wi-Fi client devices may roam. At step 406, the method includes capturing, by one or more first radios of the Wi-Fi connectivity diagnostic device, packet traffic originating from and terminating at the Wi-Fi client device on its current channel. At step 408, the method includes capturing, by one or more second radios of the Wi-Fi connectivity diagnostic device, packet traffic on an expected next channel to which the Wi-Fi client device is likely to roam. At step 410, the method includes detecting a user-defined problem event. At step 412, the method includes mapping the detected problem event to a three-dimensional representation of the environment of the building.

Referring to FIG. 5, there is illustrated a schematic diagram of a Wi-Fi connectivity diagnostic device 500, in accordance with an embodiment of the present disclosure. The Wi-Fi connectivity diagnostic device 500 comprises one or more first radios 502, one or more second radios 504, a scanning module 506, signal strength sensors 508, a predictive monitoring module 510, an event button 512, a spatial mapping module 514, and one or more third radios 516. The one or more first radios 502 are configured to capture packet traffic on the current channel of a Wi-Fi client device. The one or more second radios 504 are configured to capture packet traffic on an expected next channel to which the Wi-Fi client device may roam. The scanning module 506 is configured for automated channel scanning. The signal strength sensors 508 are configured to perform proximity measurements using received signal strength indicator (RSSI). The predictive monitoring module 510 is configured to determine potential future channels based on historical data and machine learning algorithms. The event button 512 is configured to allow user-initiated detection of problem event occurrences. The spatial mapping module 514 is configured to map captured events to a three-dimensional representation of the environment of the building. The one or more third radios 516 are configured to periodically scan Wi-Fi channels to identify new potential roaming candidates and update the predictive monitoring module with real-time data.

It may be understood by a person skilled in the art that FIG. 5 depicts a simplified schematic diagram of the Wi-Fi connectivity diagnostic device 500, for sake of clarity, which should not unduly limit the scope of the claims herein. It is to be understood that the specific implementation of the Wi-Fi connectivity diagnostic device 500 is provided as an example.

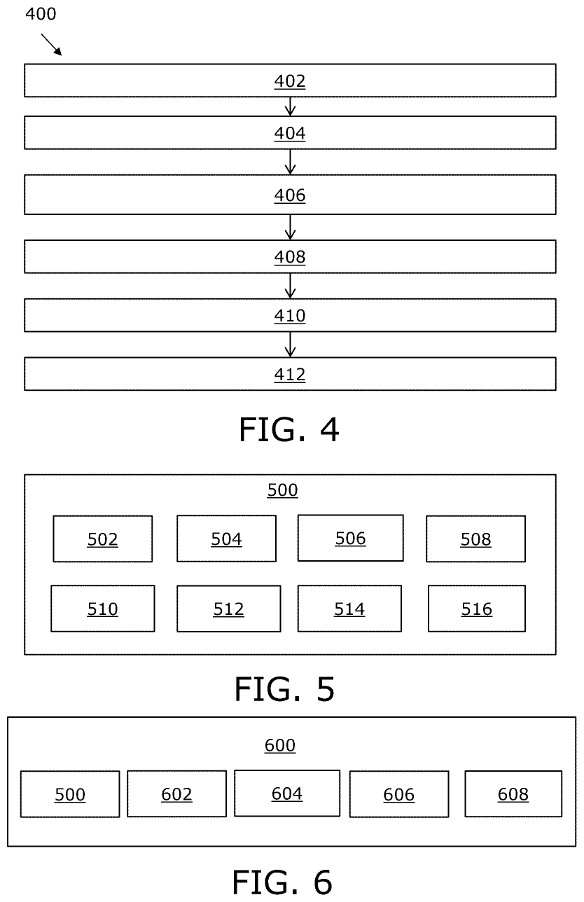

Referring to FIG. 6, there is illustrated a schematic diagram of a system 600 for Wi-Fi connectivity diagnostics in a building, in accordance with an embodiment of the present disclosure. The system 600 comprises the Wi-Fi connectivity diagnostic device 500, a processor 602, a memory 604, a user interface 606, and an adjustable antenna array 608. The processor 602 is configured to control operation of radios in the Wi-Fi connectivity diagnostic device 500, analyze roaming criteria including signal strength and network parameters, predict potential candidate channels to which the Wi-Fi client device may roam, detect problem events, and map detected problem events to a spatial floorplan of the building. The memory 604 is configured to store captured packet traffic originating from and terminating at the Wi-Fi client device, retain data for predetermined periods around the detection of problem events, save signal strength measurements and network parameters, and maintain time stamps for recorded data. The user interface 606 comprises a button (i.e., the event button 512) that is configured to allow a user to indicate the occurrence of a problem event, and an interface to display or output diagnostic information and spatial maps. The antenna array 608 is configured to dynamically adjust its orientation, configuration and signal focus to optimize the reception and capture of Wi-Fi signals based on the detected roaming criteria and current network conditions.

1. A method for Wi-Fi connectivity diagnostic in a building, the method comprises:
periodically scanning, by a Wi-Fi connectivity diagnostic device, Wi-Fi channels in the building to identify Wi-Fi client devices and access points on their current channels;
detecting roaming criteria including signal strength and network parameters to determine potential channels to which the Wi-Fi client devices may roam;
capturing, by one or more first radios of the Wi-Fi connectivity diagnostic device, packet traffic originating from and terminating at the Wi-Fi client device on its current channel;
capturing, by one or more second radios of the Wi-Fi connectivity diagnostic device, packet traffic on an expected next channel to which the Wi-Fi client device is likely to roam;
detecting a user-defined problem event;
mapping the detected problem event to a three-dimensional (X, Y, Z) representation of the environment of the building.

2. The method according to claim 1, wherein the method further comprises scanning the channels by one or more third radios to determine new potential roaming candidates.

3. The method according to claim 1, wherein the method further comprises using a pre-constructed digital model of the Wi-Fi network environment and/or previous measurements of the building to predict what is the expected next channel.

4. The method according to claim 1, wherein the method further comprises filtering captured data based on MAC addresses.

5. The method according to claim 1, wherein the method further comprises analyzing signal strength trends over time to refine predictions.

6. The method according to claim 1, wherein the method further comprises predicting what is the expected next channel for Wi-Fi client device likely to roam using historical data and machine learning algorithms.

7. The method according to claim 1, wherein detecting the problem event comprises user-initiated detection via a button on the Wi-Fi connectivity diagnostic device;
recording data for a predetermined period of time before and after the user presses the button to indicate the occurrence of the problem event, and wherein the recorded data comprises:
packet traffic captured by the first and second radios, signal strength measurements, network parameters, and time stamps of the captured data.

8. The method according to claim 1, wherein the method further comprises automatically adjusting the scanning and capturing frequencies based on detected network activity to optimize data collection efficiency.

9. The method according to claim 1, wherein the method further comprises correlating detected problem events with environmental changes such as physical obstructions or interference sources to improve troubleshooting accuracy.

10. A Wi-Fi connectivity diagnostic device, the Wi-Fi connectivity diagnostic device comprising:
one or more first radios configured to capture packet traffic on the current channel of a Wi-Fi client device;
one or more second radios configured to capture packet traffic on an expected next channel to which the Wi-Fi client device may roam;
a scanning module configured for automated channel scanning;
signal strength sensors configured for proximity measurements using received signal strength indicator (RSSI);
a predictive monitoring module configured to determine potential future channels based on historical data and machine learning algorithms;
an event button configured to allow user-initiated detection of problem event occurrences; and
a spatial mapping module configured to map captured events to a three-dimensional (X, Y, Z) representation of the environment of the building.

11. The Wi-Fi connectivity diagnostic device according to claim 10, wherein the Wi-Fi connectivity diagnostic device further comprises one or more third radios configured to periodically scan Wi-Fi channels to identify new potential roaming candidates and update the predictive monitoring module with real-time data.

12. A system for Wi-Fi connectivity diagnostics in a building, wherein the system comprises:
a Wi-Fi connectivity diagnostic device comprising:
one or more first radios configured to capture packet traffic on the current channel of a Wi-Fi client device,
one or more second radios configured to capture packet traffic on an expected next channel where the Wi-Fi client device may roam, and
optionally, one or more third radios configured to periodically scan channels in the building to identify Wi-Fi client devices and access points and update potential roaming channels;
a processor configured to:
control the operation of the multiple radios,
analyze roaming criteria including signal strength and network parameters,
predict potential channels to which the Wi-Fi client device may roam,
detect problem events, and
map detected problem events to a spatial floorplan of the building;
a memory (604) configured to:
store captured packet traffic originating from and terminating at the Wi-Fi client device,
retain data for predetermined periods around the detection of problem events,
save signal strength measurements and network parameters, and
maintain time stamps for recorded data; and
a user interface, comprising:
a button configured to allow a user to indicate the occurrence of a problem event, and
an interface to display or output diagnostic information and spatial maps.

13. The system according to claim 12, wherein the system further comprises an adjustable antenna array configured to dynamically adjust its orientation and/or configuration and signal focus to optimize the reception and capture of Wi-Fi signals based on the detected roaming criteria and current network conditions.

14. A computer program for Wi-Fi connectivity diagnostics in a building, the computer program comprising instructions which, when executed by a processor, cause a Wi-Fi connectivity diagnostic device to carry out the method according to claim 1.

15. A computer program product for Wi-Fi connectivity diagnostics in a building, the computer program product comprising a non-transitory computer-readable medium having stored thereon a program code, the program code comprising instructions which, when executed by a processor, cause a Wi-Fi connectivity diagnostic device (500) to carry out the method according to claim 1.
